(19) United States
(12) Patent Application Publication
(10) Pub. No.: US 2008/0045169 A1
(43) Pub. Date: Feb. 21, 2008

(54) METHOD AND SYSTEM FOR RADIO CONFIGURATION

(75) Inventors: Daniel P. Zetzl, Arlington Heights, IL (US); Jack Wong, Chicago, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/460,418

(22) Filed: Jul. 27, 2006

(51) Int. Cl. H04B 1/18

(52) U.S. Cl. 455/186.1; 340/825.22

(57) ABSTRACT

A system (100) and method (400) for radio configuring is provided. The method can include connecting (402) a non-volatile memory storage device (120) to a first radio (110) having a first radio configuration (112), saving (404) a list of radio configurable parameters (300) in the first radio to the non-volatile memory storage device, removing (406) the non-volatile memory storage device from the first radio, connecting (408) the non-volatile memory storage device to a second radio (130) having a second configuration (134), and copying (410) the list of radio configurable parameters from the non-volatile memory storage device to the second radio for replicating the first configuration on the second radio. The non-volatile memory storage device can be a Universal Serial Bus (USB) memory device, a portable Flash memory device, or a compact Flash device.

### FIELD OF THE INVENTION

The present invention relates to radio communication systems and, more particularly, to configuring radio communication systems.

### BACKGROUND

The use of portable electronic devices and mobile communication devices has increased dramatically in recent years. Mobile communication devices such as two-way radios can operate in various environments. Two-way radios can be mounted in vehicles for allowing communication between users over a wide area. For example, two-way radios can be deployed and mounted within police cars for providing dispatch or communication operations. In practice, the radios can be configured to operate over a common communication protocol. As one example, radios can be set to a common physical channel which allows voice and data communications to be sent to other radios that are tuned to the common channel. The radios can include configuration options which identify the communication settings and functions available to the radio.

A radio can be configured to operate with another radio by changing the radio configuration settings. For example, it may be necessary to service a radio in the field, for example, at a particular location. Portions of the configuration may not be known until the radios are tested or serviced, which may be on site or in a shop. For instance, a radio may not be receiving adequate coverage and it can be necessary to adjust the configuration to the settings of an operational radio to evaluate the coverage or the conditions. Servicing the radios generally involves changing a set of configurable options on the radio, which may be on-site. When the radios are installed in separate vehicles this can be a difficult challenge. For example, this may require multiple radio programming cables, radio configuration cables, and service aids to update a radio's configurable options during service calls to customers in the field.

Such a solution can be cumbersome because technicians may be required to carry a large amount of equipment during service calls to customers in the field. Moreover, the task may require that vehicles having the radios be in close proximity to one another. This can be a result of cable length restrictions due to the physical topology and protocol utilized. Given such restrictions, and based on the location of the radio within the vehicle, it is not always feasible to provide a physical connection between two radios. One alternative is a more time consuming process of removing the radio, updating the radio's configurable options, and reinstalling the radio. A need therefore exists for a less time consuming process that alleviates such restrictions.

### SUMMARY

Broadly stated, the invention is directed to a system and method for radio configuration. The method can include connecting a non-volatile memory storage device to a first radio having a first radio configuration, saving a list of radio configurable parameters in the first radio to the non-volatile memory storage device, removing the non-volatile memory storage device from the first radio, connecting the non-volatile memory storage device to a second radio having a second configuration, and copying the list of radio configurable parameters from the non-volatile memory storage device to the second radio for replicating the first configuration on the second radio. The non-volatile memory storage device can be a Universal Serial Bus (USB) memory device, a portable Flash memory device, or a compact Flash device.

A configuration parameter can associate a configuration option with a configuration value. In one aspect, the configuration parameters and values are copied from the first radio to the second radio via the non-volatile storage device. In a second aspect, only the configuration values are copied to the non-volatile storage device. For example, the non-volatile memory storage device can include a list of configuration parameters in a format that complies with the configuration of one or more radios. Configuration values can be saved to the configuration parameters in the non-volatile storage device such that only the values are copied between the radios.

Embodiments of the invention also concern a system for radio configuration. The system can include a non-volatile memory storage device for storing a list of radio configurable parameters, a first interface to a first radio for connecting the non-volatile memory storage device and saving a list of radio configurable values in the first radio to the list of radio configurable parameters in the non-volatile memory storage device, and a second interface to a second radio for connecting the non-volatile memory storage device to the second radio and copying the list of radio configurable parameters from the non-volatile memory storage device to the second radio for configuring the first radio.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a mobile communication system showing a non-volatile memory device in accordance with the embodiments of the invention;

FIG. 2 is a block diagram for configurating a radio in accordance with the embodiments of the invention; and

FIG. 3 is a configuration list in accordance with the embodiments of the invention.

FIG. 4 is a method for radio configuration in accordance with the embodiments of the invention; and

FIG. 5 is a mobile communication environment showing a computer and a non-volatile memory device in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” can be defined as number of suitable processors, controllers, units, or the like that carry out a pre-programmed or programmed set of instructions. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Briefly, radios can support communication over various frequencies, or channels. The radios can also scan for activity on those channels, for example, those channels for which the radio is configured to communicate. The radio can include a configuration which identifies communication functions available to the radio. As one example, the configuration can include a radio operating frequency and private line information. The radios can allow inbound communication on a channel associated with the frequency and private line. For example, a plurality of radios can be designated with the same private line and distributed to a team. Members of the team can communicate with one another since the radios are on the same private line. As an example, the private line may be a channel number, such as 1-24, that can be physically set on the radio. In the field, the radio can scan for activity on a frequency specified by the radio configuration.

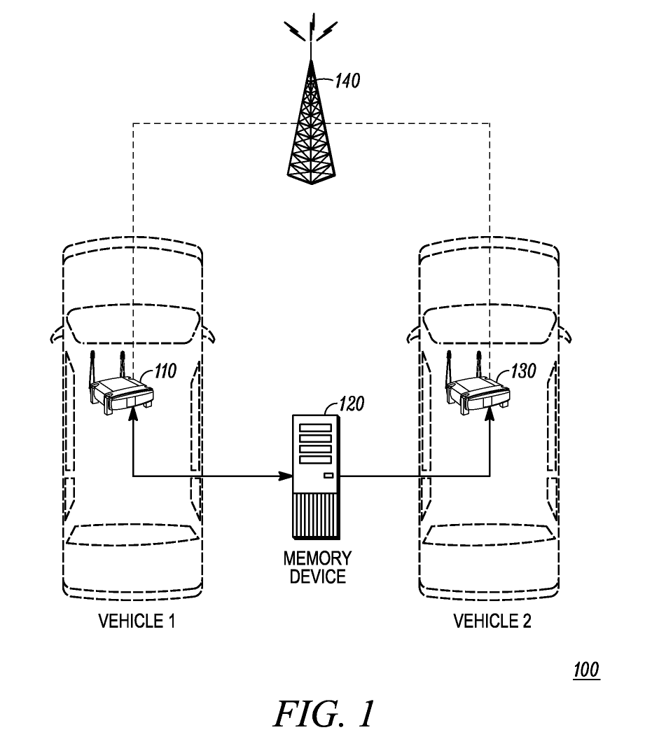

Referring to FIG. 1, a mobile communication environment 100 for providing radio communication is shown. The mobile communication environment 100 can include one or more subscribers, such as radio 110 and radio 130. A radio can be a hand-held radio, a vehicle mounted radio, a dispatch radio, or a mounted communication system. In one arrangement, the radios 110 and 130 may be mounted in a vehicle such as a police car, an ambulance, a fire truck, or the like. Understandably, the vehicles allow the users broader mobility though perhaps less portability. The radios 110 and 112 can communicate with one another, and with other radios such as a hand-held portable walkie talkie. Understandably, more than one radio can be present for providing group call or dispatch communication.

In one aspect, the mobile devices 110 and 112 can communicate with one another over a radio frequency communication link 140. As is known in the art, the radios 110 and 112 can each include a transmitter and a receiver for providing wireless communication over a radio frequency link. The radios communicate over one or more channels within a frequency band. In radio terminology, a channel can be defined as a specific radio frequency, or band of frequencies, usually described in conjunction with a predetermined letter, number, or codeword. Briefly, a radio frequency spectrum can be divided into a plurality of frequency bands such as UHF and VHF. As is known in the art, Very high frequency (VHF) is the radio frequency range from 30 MHz to 300 MHz. In contrast, Ultra high frequency (UHF) designates a range (band) of electromagnetic waves whose frequency is between 300 MHz and 3.0 GHz. UHF frequencies' propagation characteristics are ideal for short-distance terrestrial communication such as radio communication.

The radios 110 and 130 can each include a configuration which identifies communication options. For example, radio 110 can include a configuration which identifies the radio's operating frequency and the private line, though is not limited to these. Similarly, radio 130 can include a configuration which identifies the radio's operating frequency and the private line. In certain cases, it may be necessary to set a configuration of one radio to a configuration of another radio. For example, it may be necessary to configure radio 130 with the configuration of radio 110, for testing or diagnostic purposes, or for updating code. Accordingly, a non-volatile memory storage device 120 (herein termed memory storage device) can be used to copy the configuration of radio 110 to radio 130. In practice, a user can connect the memory storage device 120 to the first radio 110 to copy a configuration of the radio 110. The user can disconnect the memory storage device 120 from the first device and then connect the memory storage device 120 to the second radio 130. The user can copy the configuration of the first radio on the memory storage device 120 onto the second radio 130. The memory storage device 120 provides a portable means for copying configuration data between radio 110 and radio 130 that does not require a physical connection, such as a cloning cable. The memory storage device 120 can be a non-volatile storage device such as a Universal Serial Bus (USB) memory device, a portable Flash memory device, or a compact Flash device.

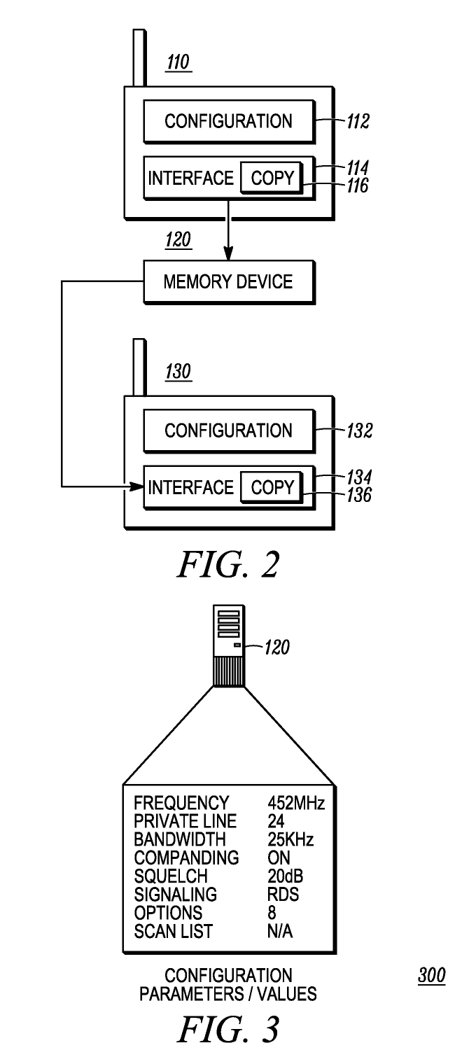

Referring to FIG. 2, a block diagram for radio configuring is shown. The block diagram 200 shows the first radio 110, the memory storage device 120, and the second radio 130. The first radio 110 can include a first configuration 112 for identifying one or more communication aspects of the first radio 110, and a first interface 114 for providing configuration data to the memory storage device 120. The first interface 114 may be a software programmable interface that resides on the first mobile device 110, or may be a hardware device that is attached to the first radio 110. The second radio 130 can include a second configuration 132 for identifying one or more communication aspects of the second radio 130, and a second interface 134 for providing configuration data to the memory storage device 120. The second interface 134 may be a software programmable interface that resides on the second mobile device 130, or may be a hardware device that is attached to the second radio 130. As one example, an interface on the radio can be a Global Core Accessory Interface (GCAI) that provides a physical and software interface to the non-volatile storage device to transfer the clonable data configuration. In one aspect, the interface can visually present a list of radio configurable parameters.

At a first time, the memory storage device 120 can be communicatively coupled to the first interface 114. For example, a user may connect the memory storage device 120 to the first radio 110 via the first interface 114. The first interface can have at least one ergonomic function 116 for copying the first configuration from the first radio 110 to the memory storage device 120. At a second time, the memory device 120 can be communicatively coupled to the second interface 134. For example, the user may disconnect the memory storage device from the first interface 114 and shortly thereafter connect the memory storage device 120 to the second radio 130 via the second interface 134. Briefly, referring to FIG. 1, this may correspond to a period of time when a technician moves from the first vehicle to the second vehicle. Understandably, embodiments of the invention are directed to a connectionless communication between the first radio 110 and the second radio 130. Due to the distance between the vehicles, the memory storage device 120 is not simultaneously connected to the first radio 110 and the second radio 130. Moreover, the physical aspects of the memory storage device provide for a single coupled connection. The second interface can have at least one ergonomic function 136 for copying the first configuration from the memory storage device 120 to the second radio 130.

For example, referring to FIG. 3, an exemplary configuration 300 is shown. The configuration 300 can be a list of configuration parameters and configuration values. A configurable parameter may be a frequency, a private line, a channel bandwidth, a companding mode, an emphasis, an option board, a squelch level, a modem channel, or a signaling type used in the radio but is not herein limited to these. Those skilled in the art can appreciate the breadth of configurable parameters internally available to a radio, or a proprietary radio operating system. The configuration value may be an alphanumeric symbol associated with the configuration parameter for identifying a radio configuration. For example, a configuration parameter such as a frequency can have an associated value of 452 MHz for identifying the operating frequency. A configuration parameter such as a private line can have a value such as 24 for identifying a sub-audible channel. Understandably, the configuration 300 is not limited to the list of parameters shown or the values shown.

In one aspect, the configuration parameters and configuration values can be stored directly on the memory storage device 120. That is, the format for the configuration 300 on the memory device 120 is a direct mapping of the memory layout for the configuration parameters and configuration values on the radio. In a second aspect, the memory storage device 120 can provide a configuration template. The configuration values can be stored to the template on the memory storage device 120 without copying the configuration parameters. That is, the configuration values alone can be copied to the memory storage device 120. The configuration 300 can be stored on the memory storage device 120 in a format that complies with a radio configuration. For example, radio 110 may have it's configuration parameters stored at a prespecified memory location in the radio 110. Configuration values are stored to the location of these configuration parameters in the radio 110. The format of the configuration 300 on the memory storage device 120 is such that configuration parameters are stored in memory in a similar format. For example, the format of the configuration parameters in the first radio 110 may be the same format for the configuration parameters in radio 130 though the values are different. Moreover, the format may be the same even though some configuration parameters may not be available to a radio. For example, radio 120 may not be configurable with a certain parameter, though the parameter can be part of the configuration 300 and simply serve as a placeholder. For example, the configuration parameter may require an external module that may not be connected to the radio 130. Understandably, the configuration parameter can serve as a placeholder until the extension module is attached.

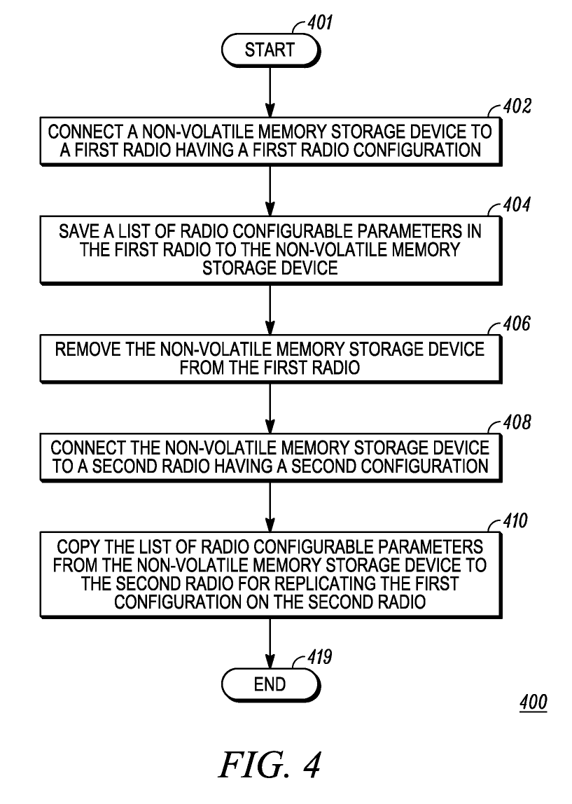

Referring to FIG. 4, a method 400 for radio configuring is shown. The method 400 can be implemented with more or less than the number of steps shown. To describe the method 400, reference will be made to FIGS. 1, 2 and 3 although it is understood that the method 400 can be implemented in any other suitable device or system using other suitable components. Moreover, the method 400 is not limited to the order in which the steps are listed in the method 400. In addition, the method 400 can contain a greater or a fewer number of steps than those shown in FIG. 2.

At step 401, the method 400 can start. At step 402, a memory storage device can be connected to a first radio having a first radio configuration. For example, referring to FIG. 1, a technician can connect the memory storage device 120 to the first radio 110 which has a first configuration. At step 404, a list of radio configurable parameters in the first radio can be saved to the memory storage device. For example, referring to FIG. 2, the first interface 114 can include an ergonomic function 116 for copying the first configuration to the memory storage device 120. The first interface 114 may also contain a display (not shown) for visually presenting the configuration parameters and values copied to the memory storage device 120. The technician can depress the ergonomic function 116 for saving the first configuration 112 on the first radio 110 to the memory storage device 120.

At step 406 the technician can remove the memory storage device from the first radio. For example, referring to FIG. 1, the technician can disconnect the memory storage device 120 from the radio 110 within the first vehicle. At step 408, the memory storage device can be connected to a second radio having a second configuration. For example, referring to FIG. 1, the technician can exit the first vehicle and enter the second vehicle. The technician can insert the memory storage device 120 into the second radio 130. The second interface 134 may visually present the configuration parameters of the first radio 110 to the technician and identify differences between the first configuration 112 and the second configuration 134.

For example, the second interface 134 may highlight or color code parameters or values that are different between the first configuration 112 and the second configuration 134. Understandably, this can assist the technician in identifying configuration differences between the first radio 110 and the second radio 130. Furthermore, the second interface 134 can record the first configuration, the second configuration, and the configuration parameters that are different for logging a service call. For example, the configuration data can be saved to a text file for later viewing or creating a history log.

At step 410, the list of radio configurable parameters can be copied from the non-volatile memory storage device to the second radio for replicating the first configuration on the second radio. Configuring the second radio with the list of parameters from the first radio can be considered an act of cloning the radios. Referring to FIG. 2, the second interface 134 can include an ergonomic function 136 for copying the first configuration on the memory storage device 120 to the second radio 120. The technician can press the ergonomic function 136 to commence the copying of the first configuration 112 to the second configuration 132. Upon the copying, the second radio 130 can operate under the configuration of the first radio 110.

In one arrangement, the second radio 130 can be booted with the list of radio configurable parameters from the memory storage device 120 prior to copying the list of radio configurable parameters to the second radio 120 for safe mode servicing. A data compatibilty error checking of radio configurable parameters can be performed prior to overwriting radio configurable parameters. For example, the technician can boot the second radio 130 with the list of configuration parameters on the memory storage device 130 to ensure that the second radio 130 will operate correctly. Moreover, the second interface 134 can perform a quick communication scan during the boot to ensure that all the configuration values provide proper operation of the second radio 130. At step 419 the method 400 can end.

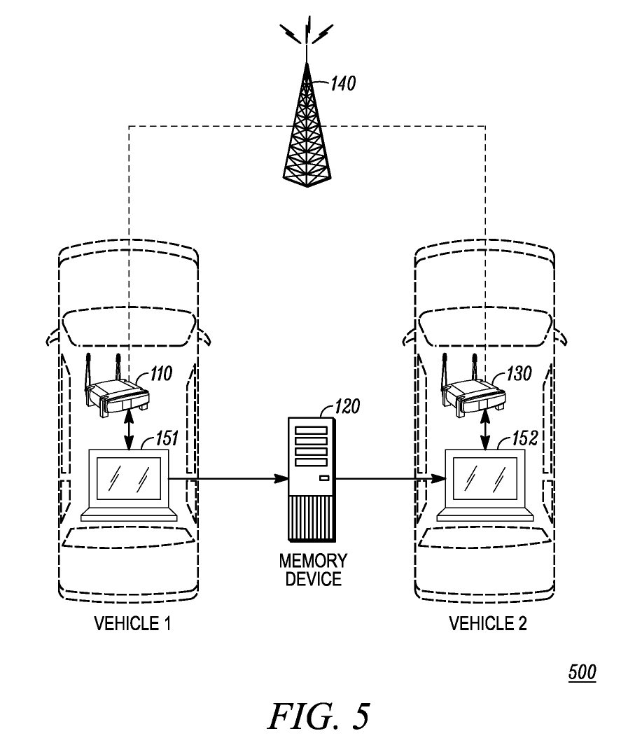

Referring to FIG. 5, another embodiment 500 of the invention is shown. In this embodiment 500, a computer can serve as the interface to the radios. For example, a technician can connect a laptop, or diagnostic system, to the first radio 110 for copying the configuration of the first radio to the memory storage device 120. The technician can disconnect the memory storage device 120 from the first computer 151 and insert the memory storage device 120 into a second computer 152, or diagnostic system, for copying the first configuration 110 to the second radio 130. The first computer 151 can run a Customer Programming Software (CPS) application on the first radio for uploading the list of radio configurable parameters from the first radio to the memory storage device. Similarly, the second computer 152 can run a Customer Programming Software (CPS) application on the second radio 130 for downloading the list of radio configurable parameters from the memory storage device 120 to the second radio. In practice, the first computer 151 and the second computer 152 can also be the same computer. For example, the technician can use the same laptop to communicate with both the first radio 110 and the second radio 130. As another example, a CPS application can use a baseline archive file and add clonable (e.g. configurable) parameters. The computer can then write to the non-volatile memory device. Advantageously, the method of using a baseline archive file does not require a radio, since the radio parameters have been cloned in the archive file.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for radio configuration, comprising:
connecting a non-volatile memory storage device to a first radio having a first radio configuration;
saving a list of radio configurable parameters in the first radio to the non-volatile memory storage device;
removing the non-volatile memory storage device from the first radio;
connecting the non-volatile memory storage device to a second radio having a second configuration; and
copying the list of radio configurable parameters from the non-volatile memory storage device to the second radio for replicating the first configuration on the second radio.

2. The method of claim 1, wherein the non-volatile memory storage device is one of a Universal Serial Bus (USB) memory device, a portable Flash memory device, or a compact Flash device.

3. The method of claim 2, wherein a configurable parameter is at least one of a frequency, a private line, a channel bandwidth, a companding mode, an emphasis, an option board, a squelch level, a modem channel, or a signaling type used in the radio.

4. A method for radio configuration, comprising:
storing a list of radio configurable parameters on a non-volatile memory storage device;
connecting the non-volatile memory storage device to a first radio;
saving a list of radio configurable values in the first radio to the list of radio configurable parameters in the non-volatile memory storage device;
removing the non-volatile memory storage device from the first radio;
connecting the non-volatile memory storage device to a second radio; and
copying the list of radio configurable parameters from the non-volatile memory storage device to the second radio for configuring the second radio with the list of configurable parameters of the first radio.

5. The method of claim 4, wherein the copying the list of radio configurable parameters includes only copying the list of radio configurable values from the non-volatile memory storage device to the second radio.

6. The method of claim 4, wherein the saving further comprises selecting an ergonomic option for copying the list of radio configurable values in the first radio to the list of radio configurable parameters in the non-volatile memory storage device.

7. The method of claim 4, wherein the copying further comprises selecting an ergonomic option for copying the list of radio configurable parameters from the non-volatile memory storage device to the second radio.

8. The method of claim 4, wherein the saving a list of radio configurable values includes formatting data on the first radio for storage on the non-volatile memory storage device in a format that is compliant with the second radio.

9. The method of claim 4, wherein a configurable parameter is at least one of a frequency, a private line, a channel bandwidth, a companding mode, an emphasis, an option board, a squelch level, a modem channel, or a signaling type used in the radio.

10. The method of claim 4, further comprising, performing a data compatibilty error checking of radio configurable parameters prior to overwriting radio configurable parameters.

11. The method of claim 4, further comprising visually presenting configuration parameters that are different between the first configuration and the second configuration.

12. The method of claim 4, further comprising recording the first configuration, the second configuration, and the configuration parameters that are different for logging a service call.

13. A system for radio configuring comprising:
a non-volatile memory storage device for storing a list of radio configurable parameters;
a first interface to a first radio for connecting the non-volatile memory storage device and saving a list of radio configurable values in the first radio to the list of radio configurable parameters in the non-volatile memory storage device; and
a second interface to a second radio for connecting the non-volatile memory storage device to the second radio and copying the list of radio configurable parameters from the non-volatile memory storage device to the second radio for cloning the first radio.

14. The system of claim 13, wherein the first interface and the second interface is a Global Core Accessory Interface (GCAI) that visually presents the list of radio configurable parameters.

15. The system of claim 14, wherein the first interface is a computer, wherein the computer runs a Customer Programming Software (CPS) application on the first radio for uploading the list of radio configurable parameters from the first radio to the non-volatile memory storage device.

16. The system of claim 15, wherein the second interface is the computer, wherein the computer runs a Customer Programming Software (CPS) application on the second radio for downloading the list of radio configurable parameters from the non-volatile memory storage device to the second radio.

17. The system of claim 15, further comprising connecting the non-volatile memory storage device to the computer and using a baseline archive file to create the list of radio configurable parameters used by the CPS.

18. The system of claim 13, wherein the non-volatile memory storage device is one of a Universal Serial Bus (USB) memory device, a portable Flash memory device, or a compact Flash device.

19. The system of claim 13, wherein a radio is a hand-held radio, a vehicle mounted radio, a dispatch radio, or a mounted communication system.

20. The system of claim 13, wherein a configurable parameter is at least one of a frequency, a private line, a channel bandwidth, a companding mode, an emphasis, an option board, a squelch level, a modem channel, or a signaling type used in the radio.
